(19) United States
(12) Patent Application Publication
(10) Pub. No.: US 2014/0325733 A1
(43) Pub. Date: Nov. 6, 2014

(54) FIREFIGHTER AND TACTICAL HARNESS

(71) Applicant: SPIDESCAPE PRODUCTS, INC., Boulder, CO (US)

(72) Inventors: Shain RAE, Sunny Isles Beach, FL (US); Dan RACZYKOWSKI, Spokane, WA (US)

(21) Appl. No.: 14/268,890

(22) Filed: May 2, 2014

Related U.S. Application Data
(60) Provisional application No. 61/819,356, filed on May 3, 2013.

(51) Int. Cl. A62B 35/00

(52) U.S. Cl. CPC A62B 35/0006
USPC 2/69

(57) ABSTRACT

A firefighter and tactical harness can be worn as a belt. If a situation arises that leg loops are desired, the firefighter and tactical harness includes a pair of pouches that can be ripped open to release the leg loops. The leg loops may each be fastened around the appropriate leg and clipped together via standard quick-connect buckles.

### CROSS-REFERENCE TO RELATED APPLICATION

This application claims the benefit of U.S. Provisional Patent Application Ser. No. 61/819,356, filed on May 3, 2013, which is incorporated by reference herein in its entirety for all purposes.

### TECHNICAL FIELD

The present invention relates generally to emergency responder equipment and more particularly to firefighter, police and military safety equipment.

### BACKGROUND

In some instances, firefighters use safety equipment such as a firefighter harness. In some cases, firefighter harnesses may be difficult to put on, uncomfortable to wear and do not include the features useful in rescuing an unconscious firefighter.

### SUMMARY

The disclosure pertains to a firefighter and tactical harness that is very easy to put on and comfortable to wear. In some embodiments, the firefighter and tactical harness is worn as a belt that can be put on simply by clipping a buckle. In some embodiments, the firefighter and tactical harness is a step-through harness. In either case, if a situation arises that leg loops are desired, the firefighter and tactical harness includes two pouches, each containing a leg loop, that can be ripped open to release the leg loops. The leg loops may each be fastened around the appropriate leg and clipped together via standard quick-connect buckles. In some embodiments the pouches may be opened and the leg loops may be released and connected in a short period of time, in some cases in less than about ten seconds.

It will be appreciated that since in some embodiments the firefighter and tactical harness is put on as a belt, it is easy to attach the firefighter and tactical harness to an unconscious firefighter and tactical or civilian. The belt may be laid out on the ground, perpendicular to the victim and at the victim's waist level. The victim may be rolled onto the belt and the buckle may be secured. Subsequently, the pouches may be opened and the leg loops may be released from the pouches and secured around each of the victim's legs. In some embodiments, if the firefighter and tactical harness is configured as a step-through harness, the harness may be secured about the wearer's waist by tightening up one or more quick adjustment mechanisms prior to opening the pouches and releasing the leg loops.

In some embodiments, the firefighter and tactical harness may be pre-rigged with a controlled descent system. The pouches holding the leg loops may be designed such that a front attachment loop of the firefighter and tactical harness may be easily accessible. As a result, in some cases, the controlled descent system, if included, may be attached to the front attachment loop before the leg loops are released and connected. Other travel restraint equipment may also be attached to the front attachment loop without having the leg loops released and connected.

In some embodiments, the firefighter and tactical harness may be equipped with webbing loops that can be used as haul loops and/or as accessory gear loops. If used as haul loops, the webbing loops may be large enough and positioned appropriately to permit a rescuer to grab one or both of the loops and pull an unconscious firefighter and tactical to safety. If used as accessory gear loops, the webbing loops may, for example, be sized to slip an axe handle through. In some cases, the webbing loops may be rated for as much as 5000 pounds.

In some embodiments, the firefighter and tactical harness may be configured to meet different usage classifications. For example, the firefighter and tactical harness may be configured as a class 1 harness (that is, to provide a waist harness or travel restraint), a class 2 harness (that is, a class 1 harness that further includes features to act as a seat harness), or a class 3 harness (that is, a class 2 harness that further includes features to act as a chest harness). Furthermore, the firefighter and tactile harness may facilitate ease of reconfiguration to the different usage classifications.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 provides a front view of an illustrative firefighter and tactical harness prior to deployment.

FIG. 2 provides a front view of an illustrative firefighter and tactical harness prior to deployment.

FIG. 3 provides a side view of the firefighter and tactical harness of FIG. 2 prior to deployment.

FIG. 4 provides a rear view of the firefighter and tactical harness of FIG. 2, shown prior to deployment.

FIG. 5 provides a front view of the firefighter and tactical harness of FIG. 1, shown after deployment.

FIG. 6 provides a side view of the firefighter and tactical harness of FIG. 2, shown after deployment.

FIG. 7 provides a rear view of the firefighter and tactical harness of FIG. 1, shown after deployment.

FIG. 8 provides a front view of an illustrative firefighter and tactical harness prior to deployment.

FIG. 9 provides a front view of an illustrative firefighter and tactical harness, shown after deployment.

FIG. 10 provides a side view of the firefighter and tactical harness of FIG. 9, shown after deployment.

FIG. 11 provides a side view of the firefighter and tactical harness of FIG. 9, shown after deployment.

FIG. 12 provides a front view of an illustrative firefighter and tactical harness, shown after deployment.

FIG. 13 provides a side view of the firefighter and tactical harness of FIG. 12, shown after deployment.

FIG. 14 provides a front view of an illustrative firefighter and tactical harness prior to deployment.

FIG. 15 provides a top side view of the firefighter and tactical harness of FIG. 14 prior to deployment.

FIG. 16 provides a top rear view of the firefighter and tactical harness of FIG. 14 prior to deployment.

FIG. 17 provides a side view of the firefighter and tactical harness of FIG. 14, shown after deployment.

FIG. 18 provides a side view of the firefighter and tactical harness of FIG. 14, shown after deployment.

FIG. 19 provides a front view of the firefighter and tactical harness of FIG. 14, shown after deployment.

FIG. 20 provides a front view of the firefighter and tactical harness of FIG. 14, shown after deployment.

FIG. 21 provides a front view of an illustrative firefighter and tactical harness prior to deployment.

FIG. 22 provides a front view of a webbed belt of the firefighter and tactical harness of FIG. 21.

FIG. 23 provides a front view of suspenders of the firefighter and tactical harness of FIG. 21.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

The disclosure pertains to a firefighter and tactical harness that can be worn as a belt. If a situation arises in which leg loops are desired, the firefighter and tactical harness includes front pouches that can be ripped open to release the leg loops. The leg loops may each be fastened around the appropriate leg and clipped together via standard quick-connect buckles.

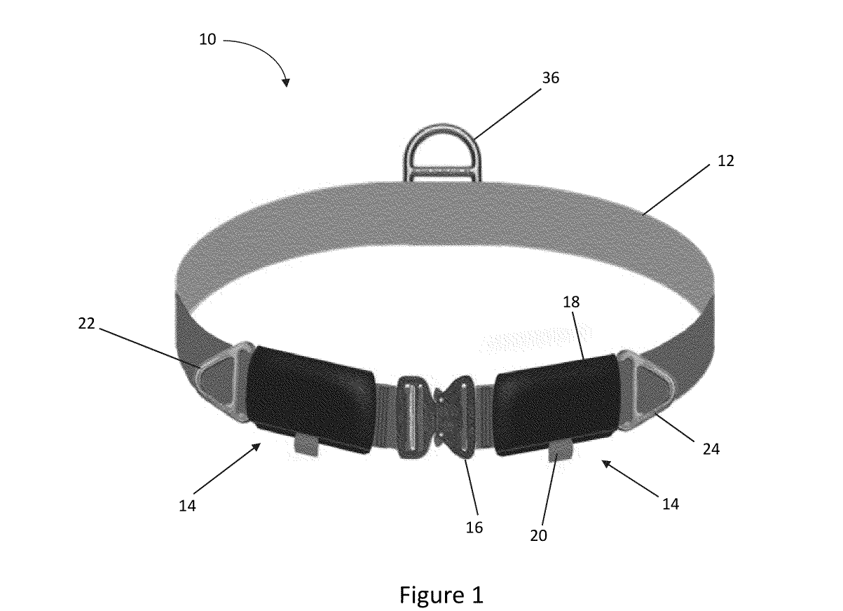

FIG. 1 shows an illustrative firefighter and tactical harness 10. The firefighter and tactical harness 10 includes a webbed belt 12 and two pouches 14 that may extend at least partially along a portion of the webbed belt 12 on either side of a central fastener 16 (e.g., a quick-connect buckle). In some embodiments, the pouch 14 may include front flaps 18 that may be secured to the pouch 14 to form compartments in which the leg loops may be stored.

Each pouch flap 18 may be releasably secured to the pouch 14 using any desired fastening method. In some embodiments, the pouch 14 may be held closed via hook-and-loop fasteners more commonly known as VELCRO®. In some embodiments, as illustrated, the pouch 14 may include a webbed access loop 20 that is secured to the front flap 18 and that provides purchase to the individual wearing the firefighter and tactical harness 10 (or the individual securing the firefighter and tactical harness 10 to an unconscious victim) so that they can open the front flap 18.

In some embodiments, as illustrated in FIG. 1, belt 12 includes an attachment component 22, 24 (e.g., a D-ring) that is sized and positioned to permit attachment of, for example, a clip or other fastener for attaching other equipment, such as a shoulder strap or suspenders.

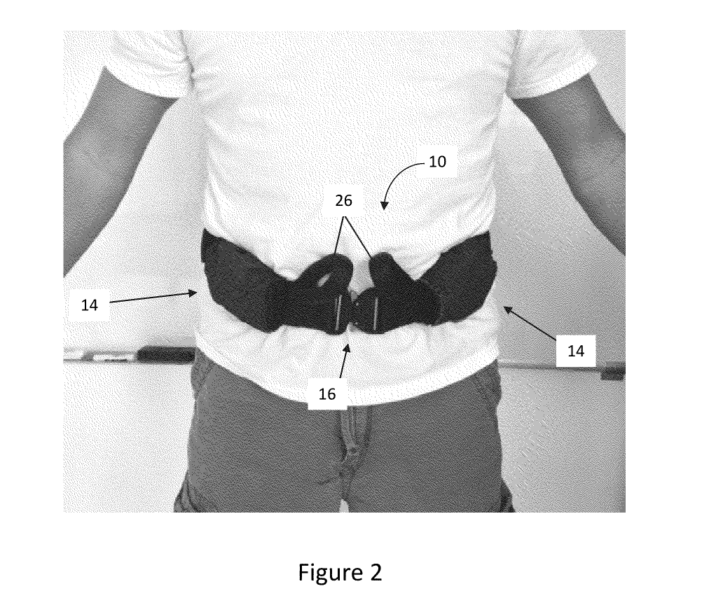

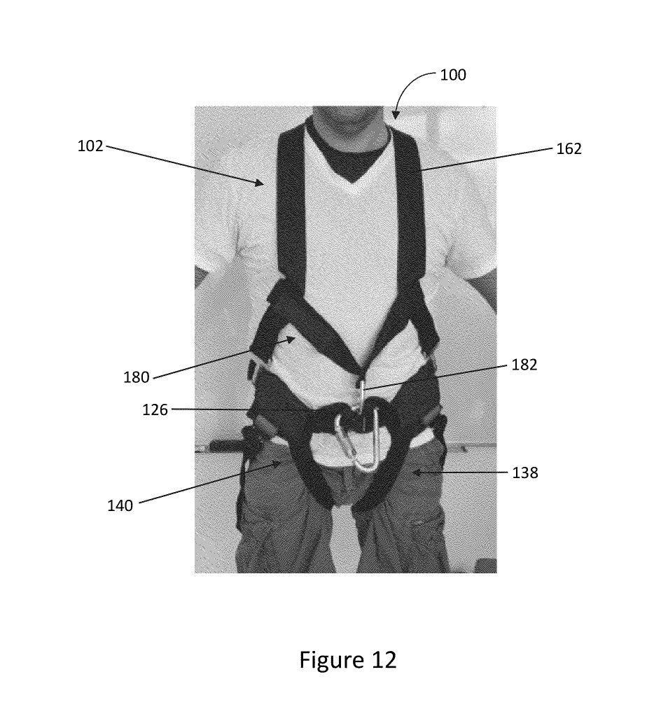

In some embodiments, as illustrated in FIG. 2, belt 12 includes a front attachment loop 26 on either side of central fastener 16. Attachment loop 26 can permit easy attachment of additional safety equipment such as a controlled descent system (not illustrated). That is, in some embodiments, the weight of the wearer may be supported through the attachment loop 26. In some embodiments, attachment loop 26 can be used to provide an additional connection point for a component of suspenders, such as shown in FIG. 12 and described below. In some embodiments, attachment loop 26 may be large enough to permit a gloved hand to grasp the loops, but not so large that it can easily snag on protrusions.

In some cases, each attachment loop 26 may independently have a length that is between about 2.5 inches and about 8 inches. In some cases, attachment loops 26 may each independently have a length that is between about 3.5 inches and about 6 inches. In some cases, attachment loops 26 may each independently have a length that is between about 4 and about 5 inches.

In some embodiments, attachment loops 26 may extend outwardly from the webbed belt 12 so that a gloved hand can slip between the loops and the webbed belt 12. In some cases, the extension of each of attachment loops 26 may be between about 0.5 inches and about 4 inches. In some cases, the extension of each of the attachment loops 26 may be between about 1 inch and about 3 inches. In some cases, the extension of each of the attachment loops 26 may be between about 1.5 inches and about 2 inches.

In some embodiments, the firefighter and tactical harness 10 may include additional connections points for other equipment. In some cases, the firefighter and tactical harness 10 may include a webbed loop disposed on belt 12. The firefighter and tactical harness 10 may also include metal loops, which may be used for attaching other equipment. Such connection points may be used either as haul loops or as accessory gear loops, as desired.

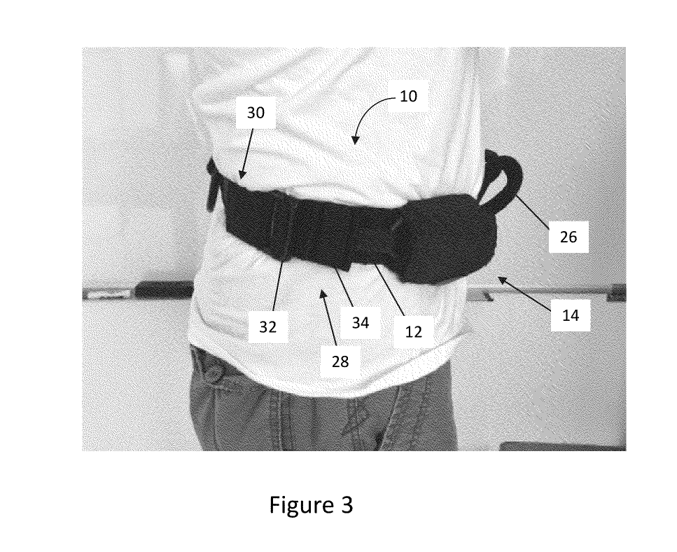

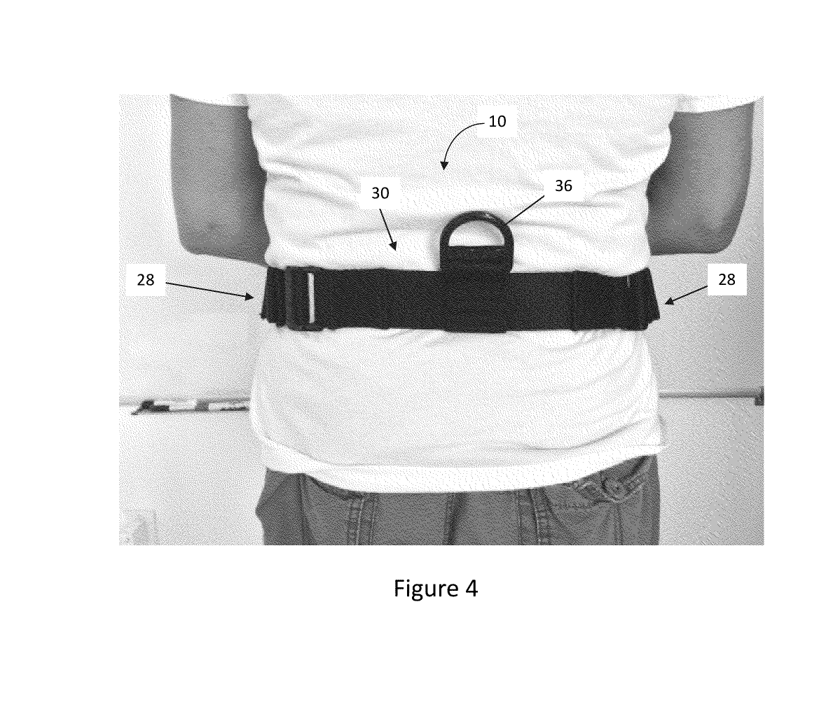

FIG. 3 shows a side view of firefighter and tactical harness 10. FIG. 4 shows a rear view of the firefighter and tactical harness 10. In FIGS. 3 and 4 additional features are visible. It can be seen that harness 10 includes a back section 30 releasably attached to belt 12 via an adjustment region 28 of webbed belt 12. Adjustment region 28 can be used to size the harness 10 in accordance with the wearer's waistline. In some embodiments, harness 10 includes an adjustment region 28 on each side of harness 10. In some embodiments, back section 30 can be removed or replaced with a different sized back section in order to adjust the size of harness 10.

Adjustment region 28 can be releasably secured to back section 30 by, for example, looping webbed belt 12 through double loop 32 and securing webbed belt 12 via hook-and-loop fasteners such as those commercially available under the VELCRO® name. In some embodiments, adjustment region 28 can be secured to belt 12 by attaching adjustment region 28 to an attachment component 22, 24. In some embodiments, attachment region 28 includes a strap 34 that can be used to keep extra length of webbed belt 12 from hanging loosely from harness 10.

FIG. 4 shows a back view of harness 10, including back section 30. Back section 30 can include an attachment component 36 (e.g., a D-ring) that is sized and positioned to permit attachment of, for example, a clip or other fastener for attaching other equipment, such as a shoulder strap or suspenders.

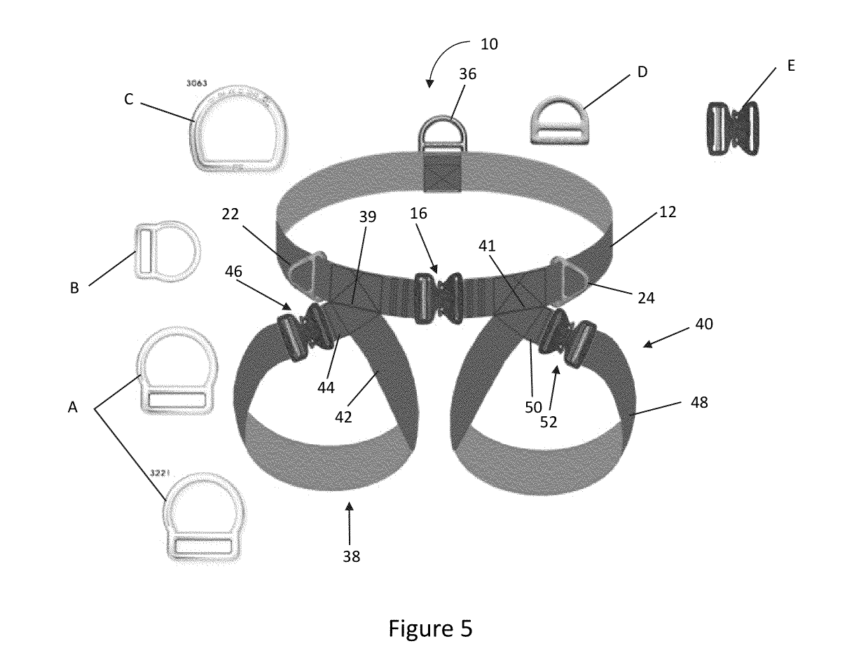

FIG. 5 shows an embodiment of firefighter and tactical harness 10, shown without pouches 14, and in a deployed configuration in which the leg loops have been released from pouches 14. In particular, leg loop 38 is configured to be secured about a right leg while a leg loop 40 is configured to be secured about a left leg. It can be seen that the leg loop 38 has a single attachment point 39 (for example, provided as stitching) to the webbed belt 12 while the leg loop 40 has a single attachment point 41 (for example, provided as stitching) to the webbed belt 12.

As shown in FIG. 5, leg loop 38 includes a longer portion 42 that extends from the attachment point 39 and wraps around the user's right leg on the outside of the leg. A shorter portion 44 extends partially around on the inside of the leg and meets the longer portion 42. A fastener 46 (e.g., a quick-connect buckle) secures the longer portion 42 to the shorter portion 44. Similarly, the leg loop 40 includes a longer portion 48 that extends from the attachment point 41 and wraps around the user's left leg on the outside of the leg. A shorter portion 50 extends partially around on the inside of the leg and meets the longer portion 48. A fastener 52 (e.g., a quick-connect buckle) secures the longer portion 48 to the shorter portion 50. The longer portion 42 (of leg loop 38) and the longer portion 48 (of leg loop 40) can be seen in FIG. 5. FIG. 5 also shows examples of various attachment point and fastener components A, B, C, D, E.

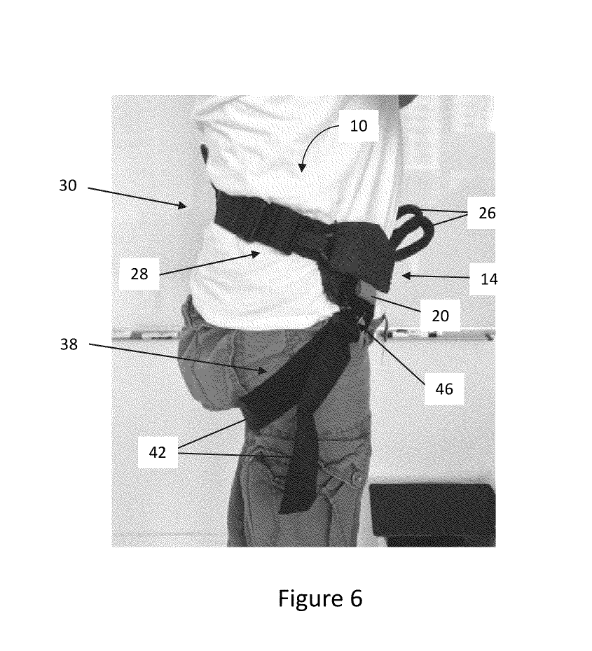

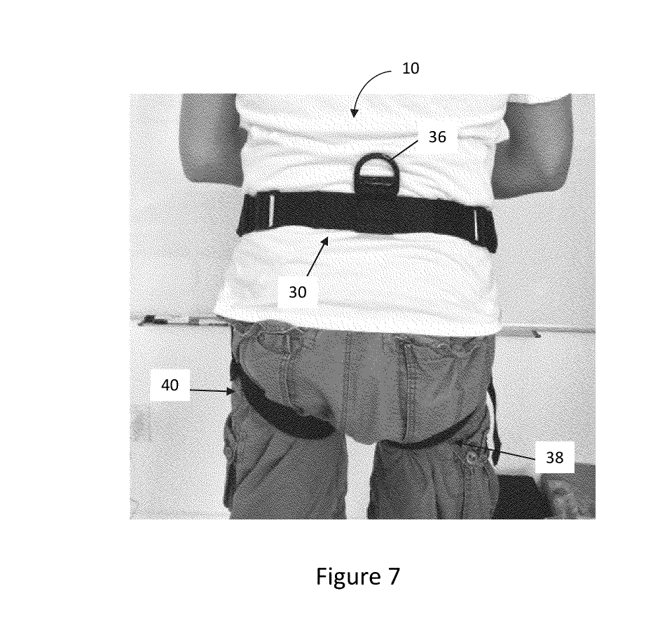

FIGS. 6 and 7 show additional views of embodiments of a firefighter and tactical harness 10 in a deployed state.

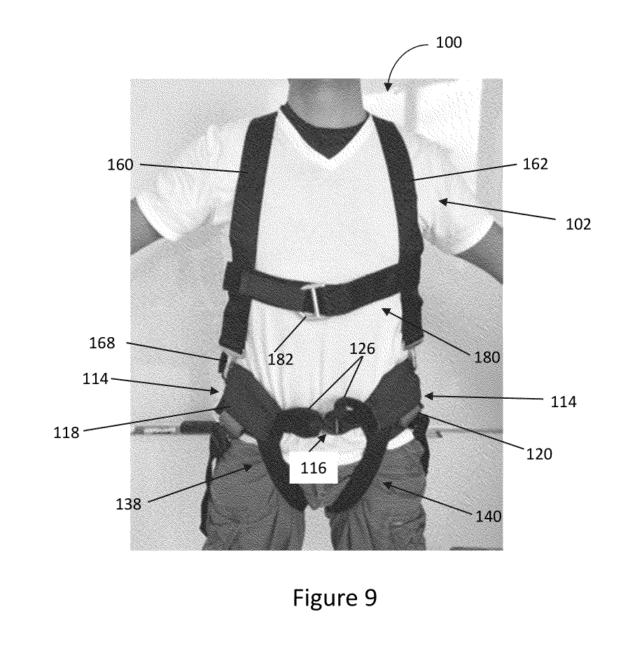

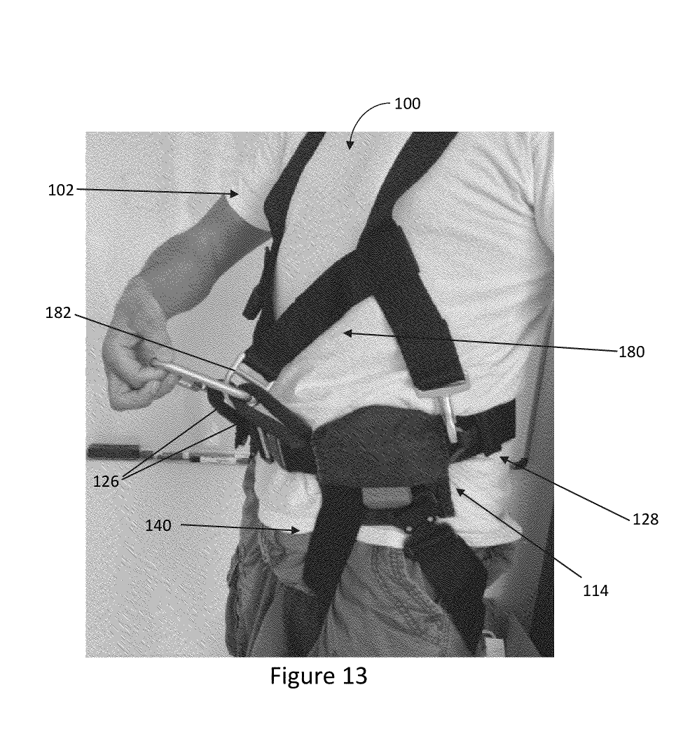

In some embodiments, as shown in FIGS. 9, 12, and 13, leg loop 38 is attached to webbed belt 12 at two attachment points and leg loop 40 is attached to webbed belt 12 at two attachment points. In some embodiments, a leg loop 38, 40 can be attached at one or more of attachment points of leg loops 38, 40 using a fastener (e.g., a D-ring, double loop, quick-connect buckle, or combination thereof). In some embodiments, a fastener can be attached to, or replace, a portion 42, 44, 48, 50 of a leg loop 38, 40. In some embodiments, one or more of a portion 42, 44, 48, 50 of a leg loop 38, 40 can have an adjustable length.

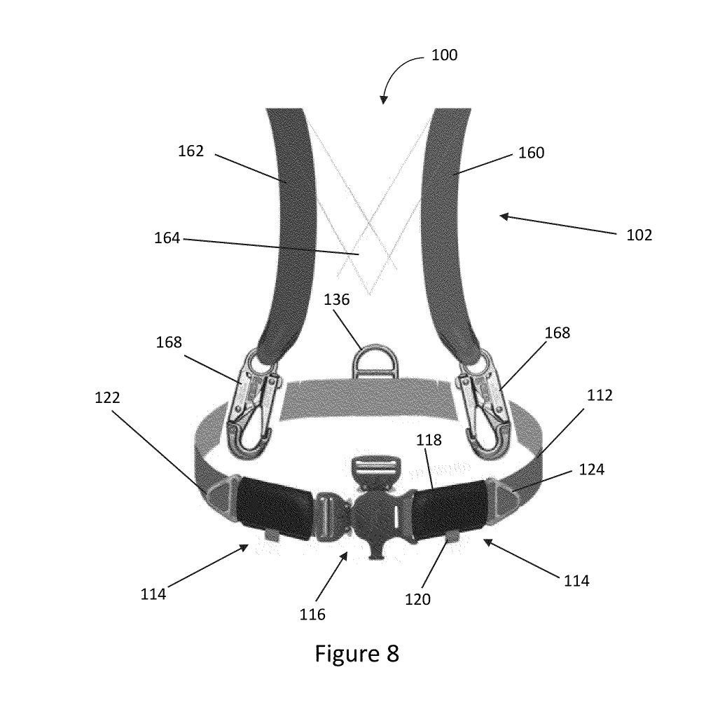

FIG. 8 shows an illustrative firefighter and tactical harness 100 including a set of suspenders 102. The firefighter and tactical harness 100 is similar to harness 10 and includes a webbed belt 112 and pouches 114 that may extend at least partially along a portion of the webbed belt 112 on either side of a central fastener 116 (e.g., a quick-connect buckle). In some embodiments, the pouch 114 may include a front flap 118 that may be secured to pouch 114 to form a compartment in which leg loops may be stored. Harness 100 further includes attachment components 122, 124 (e.g., b-rings) that are sized and positioned to permit attachment of suspenders 102 and a back section 130 that includes an attachment component 136 (e.g., a D-ring) that is sized and positioned to permit attachment of suspenders 102.

In some embodiments, as illustrated in FIGS. 9, 10, 12, and 13, belt 112 includes a front attachment loop 126 on either side of central fastener 116. Attachment loop 126 can permit easy attachment of additional safety equipment such as a controlled descent system (not illustrated). In some embodiments, attachment loop 126 can be used to provide an additional connection point for a component of suspenders 102, such as shown in FIG. 12. In some embodiments, attachment loop 126 may be large enough to permit a gloved hand to grasp the loops, but not so large that it can easily snag on protrusions.

In some cases, each attachment loop 126 may independently have a length that is between about 2.5 inches and about 8 inches. In some cases, attachment loops 126 may each independently have a length that is between about 3.5 inches and about 6 inches. In some cases, attachment loops 126 may each independently have a length that is between about 4 and about 5 inches.

In some embodiments, attachment loops 126 may extend outwardly from the webbed belt 112 so that a gloved hand can slip between the loops and the webbed belt 112. In some cases, the extension of each of attachment loops 126 may be between about 0.5 inches and about 4 inches. In some cases, the extension of each of the attachment loops 126 may be between about 1 inch and about 3 inches. In some cases, the extension of each of the attachment loops 126 may be between about 1.5 inches and about 2 inches.

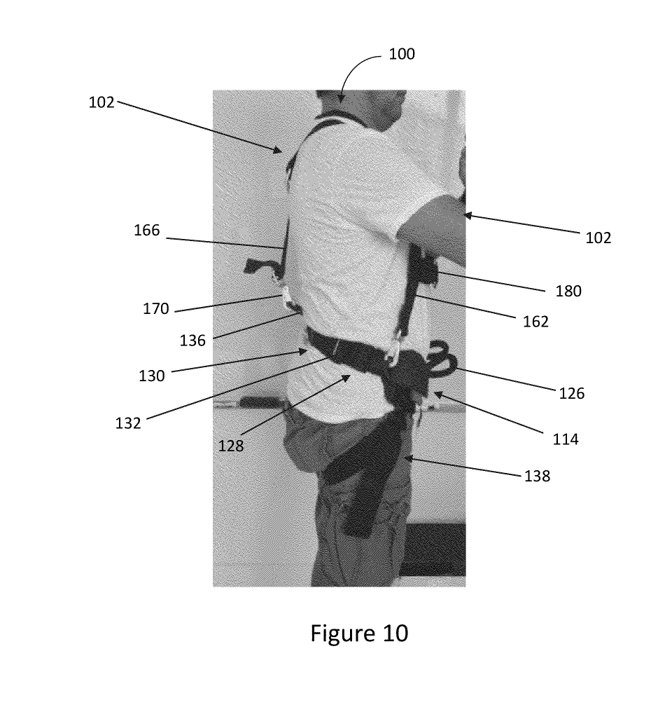

FIG. 10 shows a side view of firefighter and tactical harness 100. In FIG. 10, additional features are visible. It can be seen that back section 130 releasably is attached to belt 112 via an adjustment region 128 of webbed belt 112. Adjustment region 128 can be used to size the harness 100 in accordance with the wearer's waistline. In some embodiments, harness 100 includes an adjustment region 128 on each side of harness 100. In some embodiments, back section 130 can be removed or replaced with a different sized back section in order to adjust the size of harness 100.

Adjustment region 128 can be releasably secured to back section 130 by, for example, looping webbed belt 112 through double loop 132 and securing webbed belt 112 via hook-and-loop fasteners such as those commercially available under the VELCRO® name. In some embodiments, adjustment region 128 can be secured to belt 112 by attaching adjustment region 128 to an attachment component 122, 124. In some embodiments, adjustment region 128 includes a strap (not shown) that can be used to keep extra length of webbed belt 112 from hanging loosely from harness 100.

FIGS. 9-11 show views of an embodiment of suspenders 102 of harness 100, including shoulder straps 160, 162 connected via attachment point 164 to back strap 166. Shoulder straps 160, 162 include a fastener 168 (e.g., a clip) configured to releasably secure shoulder straps 160, 162 to attachment components 122, 124 of belt 112. Back strap 166 also includes a fastener 170 (e.g., a clip) configured to releasably secure back strap 166 to back section 130.

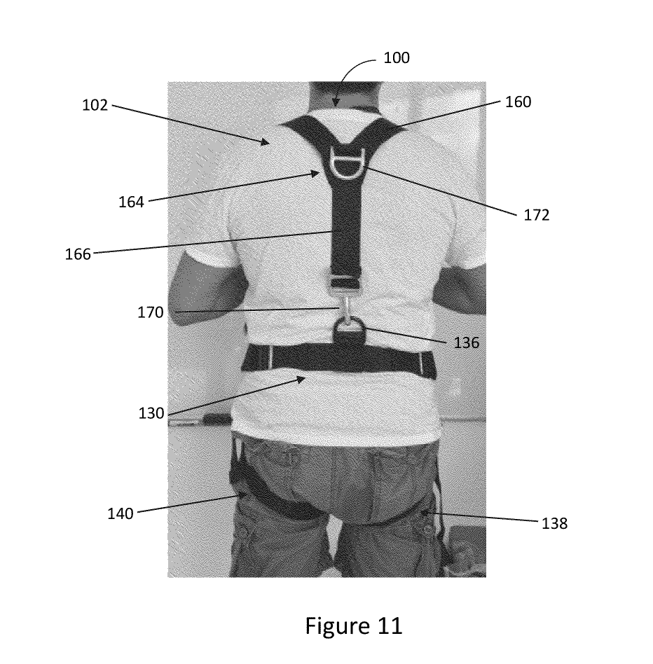

In some embodiments, as shown in FIG. 11, suspenders 102 include additional connection points, such as attachment component 172 in order to permit easy attachment of additional safety equipment such as a controlled descent system (not illustrated).

In some embodiments, as shown in FIGS. 9, 12, and 13, suspenders 102 can include one or more chest strap 180. Chest strap 180 can be configured to be adjustable in length in order to size chest strap 180 in accordance to the wearer's chest or to provide sufficient length to attach chest strap to an attachment loop 126. In some embodiments, chest strap 180 includes an attachment component 182 (e.g., a D-ring, buckle, or loop) to facilitate attachment of additional safety equipment, tools, or to attach chest strap 180 to an attachment loop 126.

The pouch flap 118 may be releasably secured to pouch 114 using any desired fastening method. In some embodiments, the pouch 114 may be held closed via hook-and-loop fasteners more commonly known as VELCRO®. In some embodiments, as illustrated, the pouch 114 may include a webbed access loop 120 that is secured to the front flap 118 and that provides purchase to the individual wearing the firefighter and tactical harness 100 (or the individual securing the firefighter and tactical harness 100 to an unconscious victim) so that they can open the front flap 118.

In some embodiments, the firefighter and tactical harness 100 may include additional connections points for other equipment. In some cases, the firefighter and tactical harness 100 may include a webbed loop disposed on belt 112. The firefighter and tactical harness 100 may also include metal loops, which may be used for attaching other equipment. Such connection points may be used either as haul loops or as accessory gear loops, as desired.

FIGS. 9-13 show embodiments of firefighter and tactical harness 100, shown in a deployed configuration in which the leg loops have been released from pouches 114. In particular, leg loop 138 is configured to be secured about a right leg while a leg loop 40 is configured to be secured about a left leg. As with leg loops 38, 40, leg loops 138, 140 can each be attached to webbed belt 112 via one or two attachment points. Leg loops 138, 140 can be configured similarly to leg loops 38, 40, as described above.

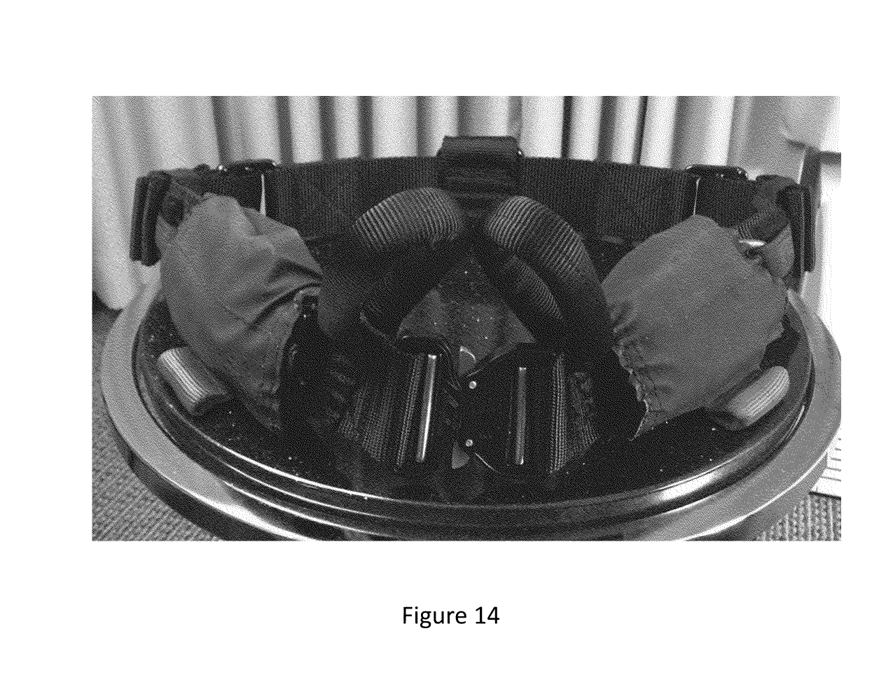

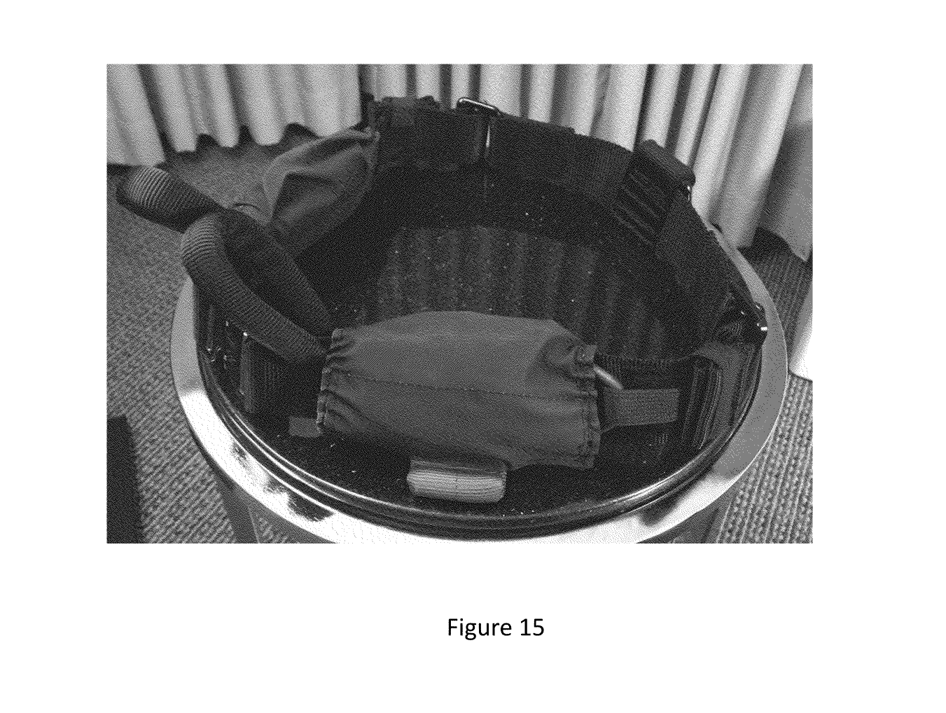

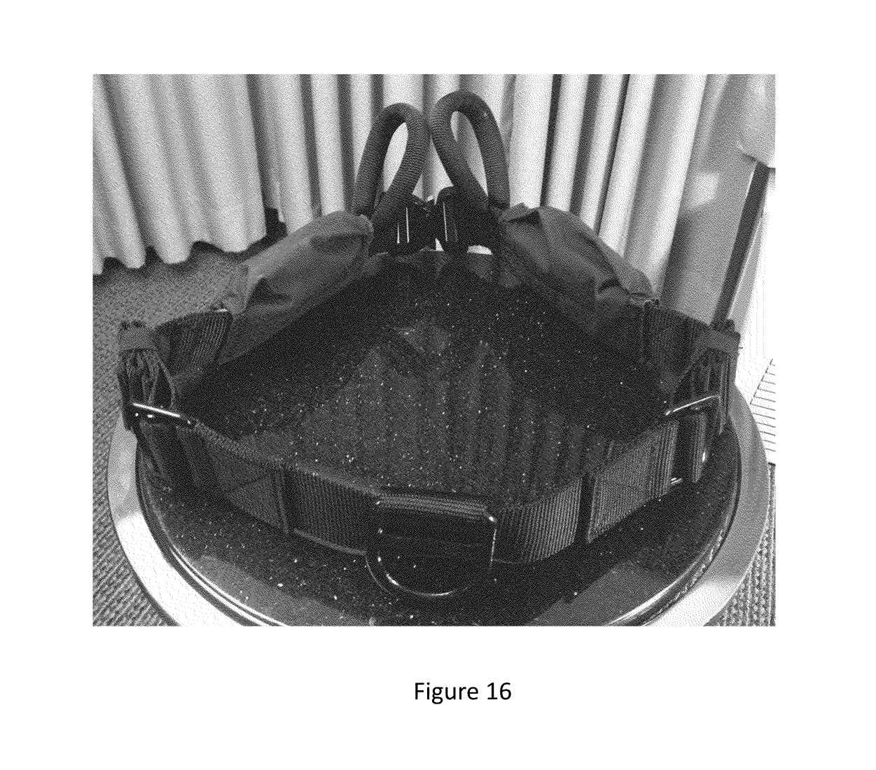

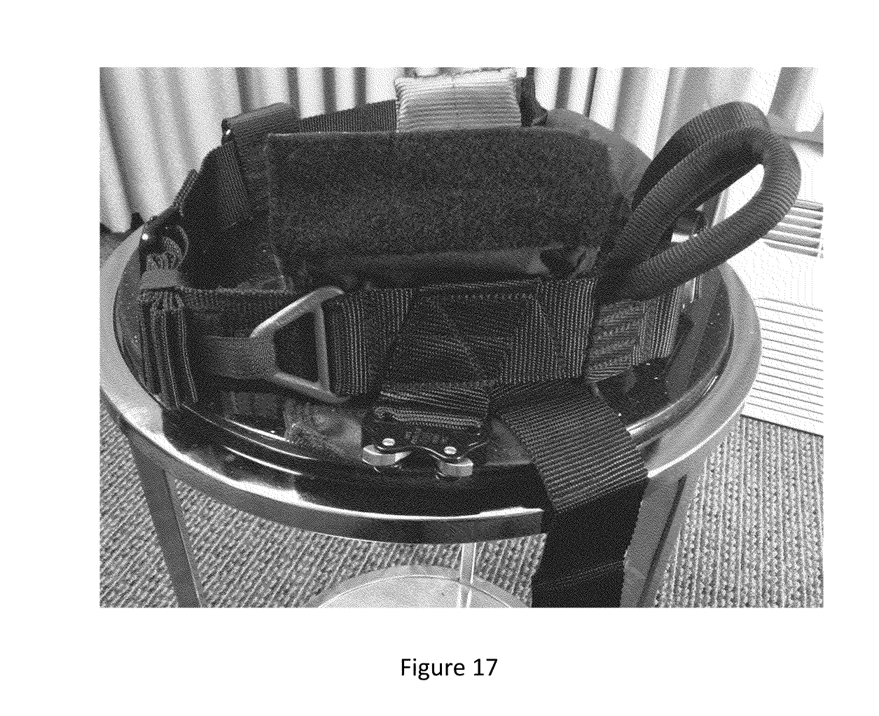

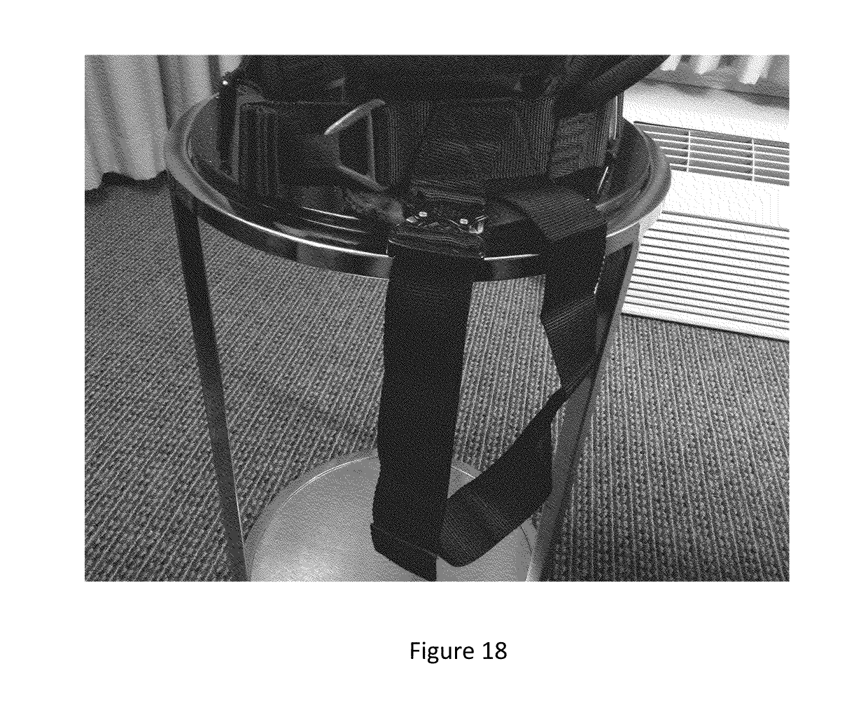

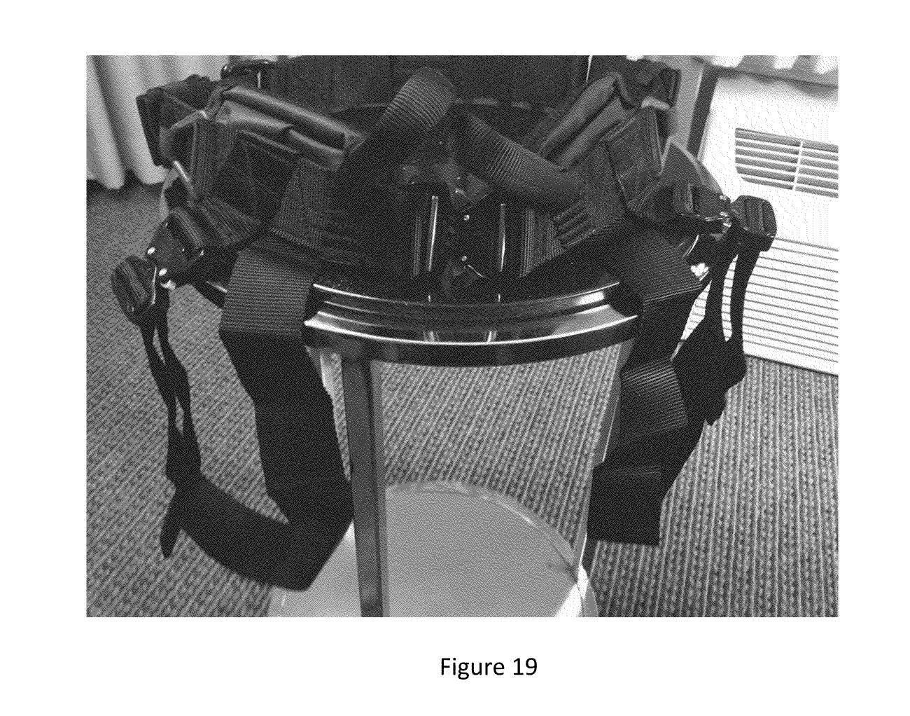

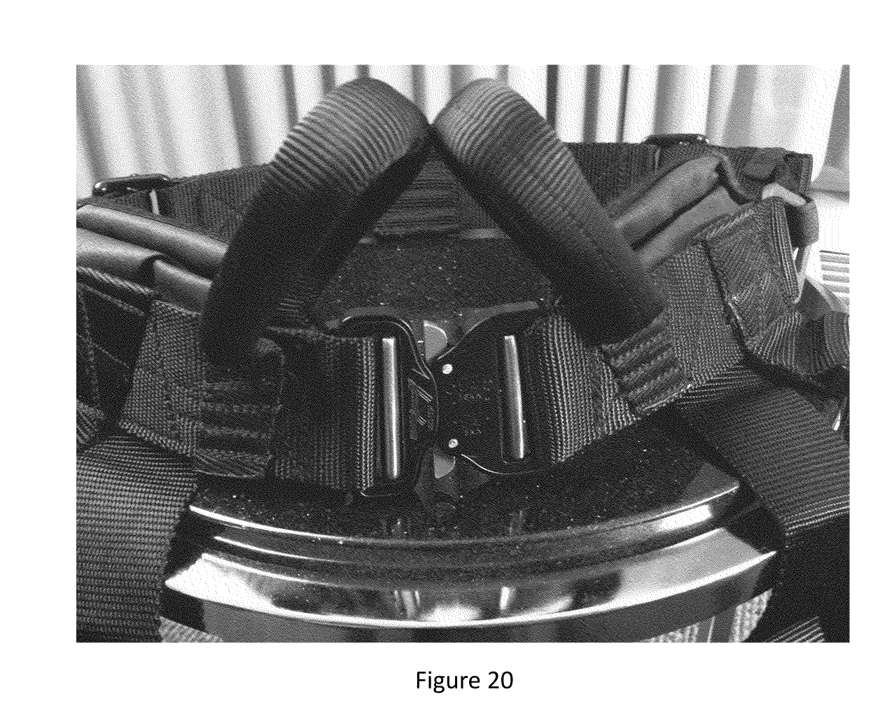

FIGS. 14-20 show additional views of various embodiments of a firefighter and tactical harness.

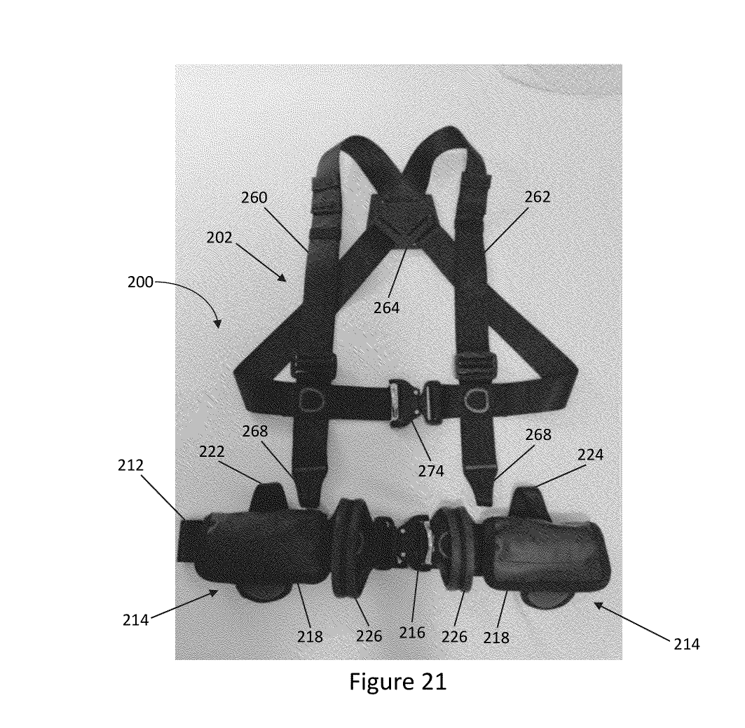

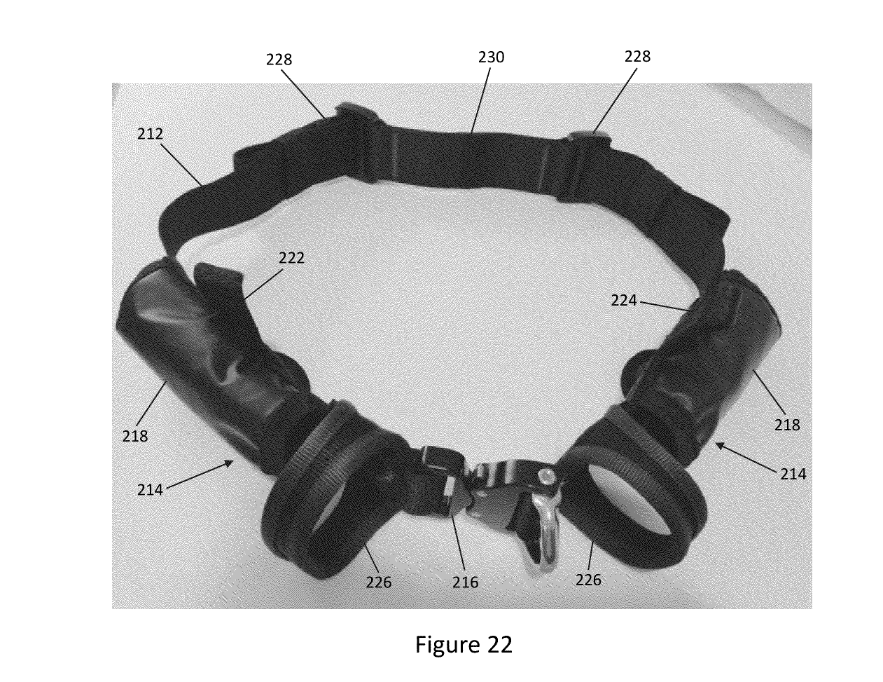

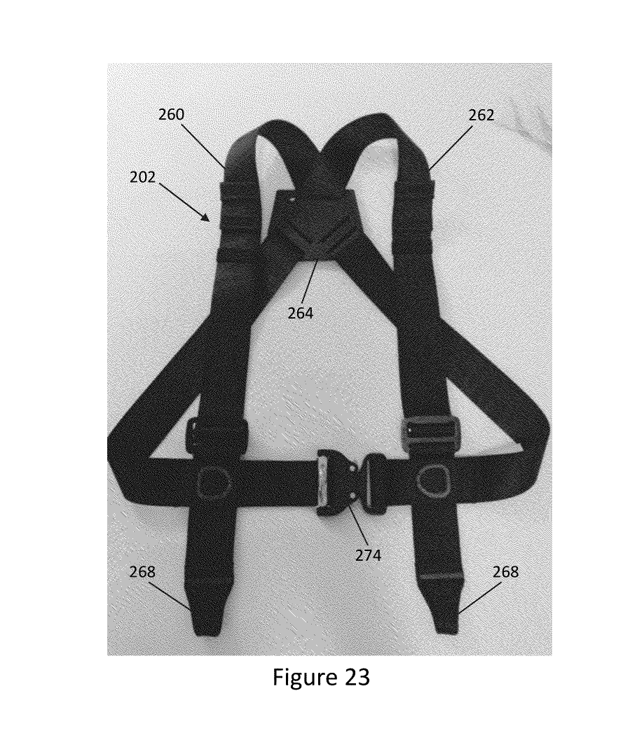

FIGS. 21-23 shows an illustrative firefighter and tactical harness 200 including a set of suspenders 202 (see FIGS. 21 and 23). The firefighter and tactical harness 200 is similar to harnesses 10 and 100 and includes a webbed belt 212 and pouches 214 that may extend at least partially along a portion of the webbed belt 212 on either side of a central fastener 216 (e.g., a quick-connect buckle). In some embodiments, the pouch 214 may include a front flap 218 that may be secured to pouch 214 to form a compartment in which leg loops may be stored. Harness 200 further includes attachment components 222, 224 (e.g., webbed loops) that are sized and positioned to permit attachment of suspenders 202 and an adjustable back section 230 (see FIG. 22).

In some embodiments, belt 212 includes a front attachment loop 226 on either side of central fastener 216. Attachment loop 226 extends generally forwardly of webbed belt 212. Attachment loop 226 can permit easy attachment of additional safety equipment such as a controlled descent system (not illustrated). In some embodiments, attachment loop 226 can be used to provide an additional connection point for a component of suspenders 202 (not illustrated). Each attachment loop 226 may have any appropriate diameter. In some embodiments, attachment loop 226 may be large enough to permit a gloved hand to grasp the loops, but not so large that it can easily snag on protrusions.

In some embodiments, the adjustable back section 230 is releasably attached to belt 212 via one or more adjustment regions 228 (see FIG. 22) of webbed belt 212. Adjustment region 228 can be used to size the harness 200 in accordance with the wearer's waistline. In some embodiments, harness 200 includes an adjustment region 228 on each side of harness 200. In some embodiments, back section 230 can be removed or replaced with a different sized back section in order to adjust the size of harness 200. Adjustment region 228 can be releasably secured to back section 230 using similar components to those described above in connection with harness 100.

FIGS. 21 and 23 show views of an embodiment of suspenders 202 of harness 200, including shoulder straps 260, 262 that slidably cross at an attachment point 264 configured to be disposed proximate the upper back of the wearer. Shoulder straps 260, 262 include a fastener 268 (e.g., a clip) configured to releasably secure shoulder straps 260, 262 to attachment components 222, 224 of belt 212. After crossing at the attachment point 264, the shoulder straps 260, 262 are coupled to the opposite shoulder strap 262, 260 (for example, via stitching). That is, the shoulder straps 260, 262 are configured to extend from the back of the wearer to the front of the wearer and couple to the opposite shoulder strap 262, 260. The ends of the shoulder straps 260, 262 couple to a central fastener 274 (e.g., a quick-connect buckle).

The pouch flap 218 may be releasably secured to pouch 214 using any desired fastening method. In some embodiments, the pouch 214 may be held closed via hook-and-loop fasteners more commonly known as VELCRO®.

In some embodiments, the firefighter and tactical harness 200 may include additional connections points for other equipment. In some cases, the firefighter and tactical harness 200 may include metal loops, which may be used for attaching other equipment. Such connection points may be used either as haul loops or as accessory gear loops, as desired.

In some embodiments, as illustrated, the firefighter and tactical harnesses 10, 100, and 200 include a first quick adjustment mechanism in adjustment regions 28, 128, and 228, respectively. The quick adjustment mechanisms may be used to quickly tighten up the firefighter and tactical harness 10, 100, and 200. In some embodiments, emergency responders may have their pants tucked into their boots. When they receive a call, they jump into their boots and pull their pants up to their waist. The firefighter and tactical harness 10, 100, and 200 may, for example, be loosely secured about their pants. Once they pull up their pants, they can tighten the firefighter and tactical harness 10, 100, and 200 by adjusting the size at adjustment region 28, 128, and 228.

The firefighter and tactical harnesses 10, 100, and 200 may be made of any desired material. In some embodiments, at least portions of the firefighter and tactical harnesses 10, 100, and 200 are made of NYLON®. In some embodiments, at least portions of the firefighter and tactical harnesses 10, 100, and 200 are made of polyester. In some embodiments, at least portions of the firefighter and tactical harnesses 10, 100, and 200 are made of KEVLAR®.

Various modifications and additions can be made to the exemplary embodiments discussed without departing from the scope of the present invention. Accordingly, the scope of the present invention is intended to embrace all such alternatives, modifications, and variations as fall within the scope of the claims, together with all equivalents thereof.

What is claimed:

1. A firefighter harness comprising:
a webbed belt including a fastener;
two pouches, each of the two pouches positioned on an opposite side of the fastener, each of the two pouches configured to releasably store a leg loop;
leg loops secured to the webbed belt; and
an attachment loop extending from a location on the webbed belt between the fastener and at least one of the two pouches.

2. The firefighter harness of claim 1, further comprising an attachment component, the attachment component being configured to attach a set of suspenders.

3. The firefighter harness of claim 2, further comprising a set of suspenders releasably attached to the attachment component.

4. The firefighter harness of claim 1, further comprising a back section that is releasably attached to the webbed belt.

5. The firefighter harness of claim 4, wherein back section is releasably attached to the webbed belt via an adjustment region of the webbed belt.

6. The firefighter harness of claim 5, wherein the adjustment region includes at least one quick adjustment mechanism configured to allow a user to quickly cinch up the firefighter harness.

7. The firefighter harness of claim 1, wherein the attachment loop is a first attachment loop and the location on the webbed belt is a first location, the first attachment loop extending from the first location on the webbed belt between the fastener and one of the two pouches, and further comprising a second attachment loop extending from a second location on the webbed belt between the fastener and the other of the two pouches.

8. A method of securing a firefighter harness having a belt, a buckle, two pouches, two leg loops, each of the two pouches storing one of the two leg loops, and an attachment loop extending from a location on the belt between the buckle and at least one of the two pouches, the method comprising:
fastening the belt about a wearer's waist by buckling the buckle;
opening the two pouches to release the two leg loops;
securing each of the two leg loops to a leg of the wearer; and
attaching additional equipment to the attachment loop.

9. The method of claim 8, wherein the belt is fastened about the wearer's waist by rolling the wearer onto the belt.

10. The method of claim 8, further comprising attaching a set of suspenders to the belt.

11. The method of claim 10, wherein the set of suspenders includes a chest strap.

12. The method of claim 11, further comprising attaching the chest strap to the belt.

13. The method of claim 8, wherein the harness further includes an adjustment region, and wherein the method further includes adjusting a size of the harness with the adjustment region.

14. The method of claim 13, wherein the adjustment region includes a quick adjustment mechanism, and wherein adjusting the size further includes adjusting the size with the adjustment mechanism.

15. The method of claim 13, further comprising removing the back section from the harness.

16. The method of claim 13, further comprising adjusting a size of the harness with the adjustment region.

17. The method of claim 13, wherein the harness further includes a back section, and the size is adjusted by removing or exchanging the back section.

18. The method of claim 13, wherein attaching the additional equipment to the attachment loop includes attaching a controlled descent system to the attachment loop.

19. A method of securing a firefighter harness having a belt including two pouches, each of the two pouches storing a leg loop, and the firefighter harness further having a set of suspenders, the method comprising:
disposing the belt about a wearer's waist;
opening the two pouches to release the leg loops;
securing each of the leg loops to a leg of the wearer; and
attaching the set of suspenders to the belt.

20. The method of claim 19, wherein the set of suspenders includes a chest strap, the method further comprising attaching the chest strap to the belt.
